(19) United States
(12) Patent Application Publication
(10) Pub. No.: US 2005/0248800 A1
(43) Pub. Date: Nov. 10, 2005

(54) Method and apparatus to set print options

(76) Inventor: Jun-young Choi, Suwon-si (KR)

Correspondence Address: STANZIONE & KIM, LLP, 919 18TH STREET, N.W., SUITE 440, WASHINGTON, DC, 20006, US

(21) Appl. No.: 11/120,954

(22) Filed: May 4, 2005

(30) Foreign Application Priority Data
May 7, 2004 (KR) 2004-32145

(51) Int. Cl. G06F 15/00

(52) U.S. Cl. 358/1.13; 358/1.15

(57) ABSTRACT

A print option setting method of a print option setting apparatus to set print options of a document includes receiving a user input signal to request printing of the document, determining whether a first setting information of the print options corresponding to the document exists in a storage unit, and if it is determined that the first setting information which is set in a previous printing of the document exists in the storage unit, displaying a print option setting window to include the first setting information. Accordingly, the print option setting apparatus automatically reflects the print options used when a document has been previously printed, thus enabling a user to avoid having to repeatedly set the print options.

### CROSS-REFERENCE TO RELATED APPLICATIONS

This application claims the benefit under 35 U.S.C. § 119 from Korean Patent Application No. 2004-32145, filed on May 7, 2004, the entire content of which is incorporated herein in its entirety by reference.

### BACKGROUND OF THE INVENTION

1. Field of the Invention

The present general inventive concept relates to a print option setting apparatus and a method thereof, and more particularly, to a print option setting apparatus and a method thereof capable of automatically setting print options previously used to print a document to subsequently print the same document.

2. Description of the Related Art

Typically, a printer driver converts a document created by an application program into print data to be printed, and provides a user interface (UI) window in order for a user to set print options for the document. For example, the print options can include a number of copies, kinds of paper, resolution, etc. The print data is data of a format that an image-forming apparatus can recognize, and the UI window is a window used to set the print options.

Thus, if a user wishes to print a document, the user can change initial values of print options (e.g., default values) using the UI window provided by the printer driver. The printer driver generates the print data according to the print options including the initial values of which have been changed, and sends the generated print data to the image-forming apparatus. Accordingly, the document is printed by the image-forming apparatus based on the print options changed by the user.

However, if the user subsequently requests the image-forming apparatus to re-print the same document, the printer driver provides the user with the UI window on which the initial values of the print options are again displayed. Thus, if the user subsequently wishes to print the document according to the same print options previously used, the user has to re-set the print options to be the same as the print options previously used to print the document.

That is, whenever the user repeatedly prints the document using a conventional printer driver, the user has to manually repeatedly set the print options one by one so that the print options have the same values as the print options previously used. In particular, if many print options were previously changed from the initial values, the user has to remember all of the print options, and if the user can not remember all of the print options previously used, the user has to continuously change the print options and print the document until the same printout can be obtained.

### SUMMARY OF THE INVENTION

The present general inventive concept provides a print option setting apparatus and a method capable of solving problems associated with manually setting specified print options that are previously used when documents are to be re-printed according to the specified print options.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a print option setting method to set print options of a document, the method comprising: receiving a user input signal to request printing of the document, determining whether a first setting information of the print options corresponding to the document exists in a storage unit, and if it is determined that the first setting information set in a previous printing of the document exists in the storage unit, displaying a print option setting window to include the first setting information.

The determining of whether the first setting information of the print options corresponding to the document exists in the storage unit may further comprise checking attribute information of the document and, if the first setting information corresponding to the checked attribute information exists, determining that the document has previously been printed based on the first setting information.

The displaying of the print option setting window may further comprise displaying the print option setting window to include the first setting information, and printing the document based on the displayed first setting information according to the user input signal.

If the first setting information is changed to a second setting information according to the user input signal, the method may further comprise displaying the changed second setting information on the print option setting window, and printing the document based on the changed second setting information.

Further, the print option setting method may further comprise updating the first setting information to the second setting information for storage in the storage unit.

The print option setting method may further comprise: if it is determined that the first setting information corresponding to the checked attribute information does not exist in the storage unit, displaying the print option setting window to include default values of the print options.

Further, if the document is printed after the default values displayed on the print option setting window are changed to a third setting information, the method may further comprise matching the third setting information with the attribute information of the document for storage in the storage unit.

Further, if a predetermined time lapses after the default values of the print options are changed to one of the first, second, and third setting information, the one of the first, second, and third setting information to which the default values are changed may be deleted from the storage unit.

The determining of whether the first setting information of the print options corresponding to the document requested to be printed exists in the storage unit may be selectively performed when a file format of the document is included in a predetermined group of specified formats.

The print options may include at least one of a paper size, a number of copies per page, a print range, a print orientation, a number of copies, and a print quality, and the attribute information may include at least one of a most recent edit date of the document, a file name of the document, a file size of the document, and a storage location of the document.

Further, the print option setting apparatus may be installed in a printer driver or an image-forming apparatus that prints the document.

The foregoing and/or other aspects and advantages of the present general inventive concept are also achieved by providing a print option setting apparatus to set print options of a document, comprising: a setting information decision unit to determine whether a first setting information corresponding to the document exists when printing of the document is requested, a setting information management unit to store the first setting information, which is set in a previous printing of the document, and a setting window generation unit to input the first setting information from the setting information management unit when it is determined that the first setting information exists in the setting information management unit, and to generate and display a print option setting window to include the first setting information.

If the setting information decision unit determines that the first setting information corresponding to attribute information associated with the document exists in the setting information management unit, the setting information decision unit determines that the document has previously been printed based on the first setting information.

If the first setting information displayed on the print option setting window is changed to a second setting information through a user input unit, the setting window generation unit generates the print option setting window to include the second setting information.

Further, if the document is printed based on the second setting information, the setting information management unit updates the first setting information according to the second setting information for storage in the setting information management unit.

In particular, if the setting information decision unit determines that the first setting information does not exist in the setting information management unit, the setting window generation unit generates the print option setting window to include default values of the print options.

Further, if printing is requested after the default values displayed on the print option setting window are changed to a third setting information through the user input unit, the setting information management unit matches the third setting information with the attribute information of the document for storage in the setting information management unit.

If a predetermined time lapses after the default values of the print options are changed to one of the first, second, and third setting information, the setting information management unit deletes the one of the first, second, and third setting information to which the default values are changed from the setting information management unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a print data output apparatus to which a print option setting part is applied according to an embodiment of the present general inventive concept;

FIG. 2 is a block diagram illustrating the print option setting part of the print data output apparatus of FIG. 1;

FIG. 3 is a view illustrating a user interface including an exemplary print option setting window displayed on a display unit by a print driver unit of FIG. 1;

FIGS. 4A to 4D are views illustrating the user interface including exemplary print option setting windows displayed on the display unit by the printer driver unit of FIG. 1;

FIG. 5 is a flow chart illustrating a method of printing documents using the print option setting part of FIG. 1;

FIG. 6 is a flow chart illustrating an operation S580 of the method of printing documents using the print option setting part of FIG. 5; and

FIG. 7 is a block diagram illustrating an image-forming device to which a print option setting part is applied according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

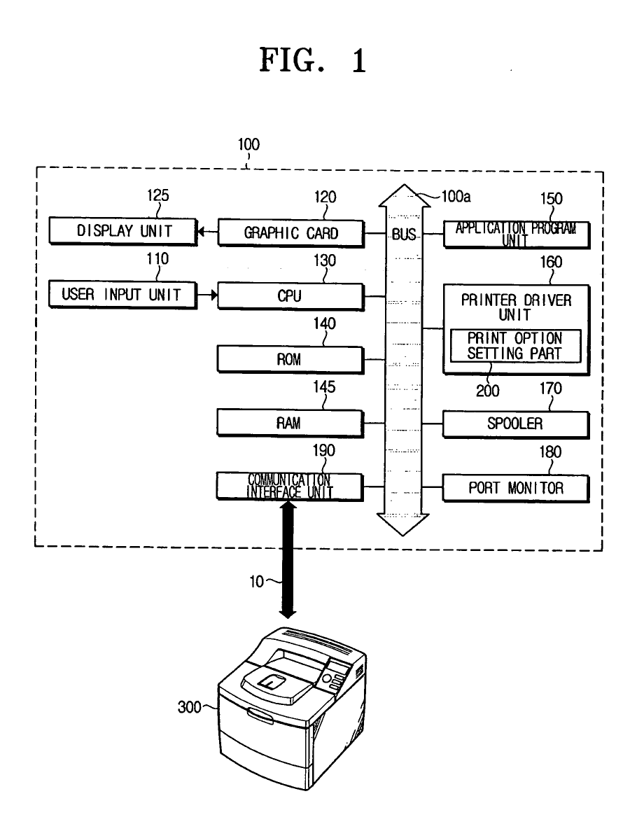

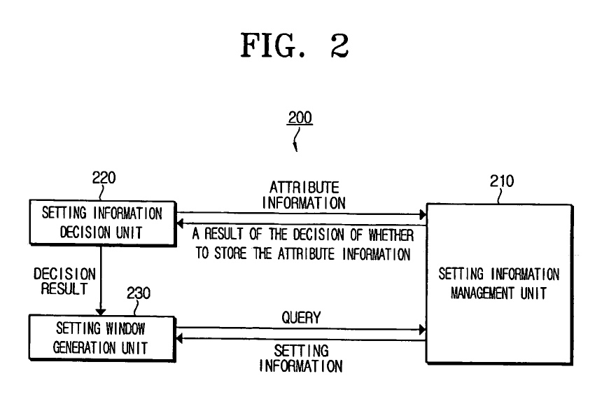

FIG. 1 is a block diagram illustrating a print data output apparatus 100 to which a print option setting part 200 is applied according to an embodiment of the present general inventive concept, and FIG. 2 is a block diagram illustrating the print option setting part 200 of the print data output apparatus 100 of FIG. 1.

As illustrated in FIG. 1, the print data output apparatus 100 to which the print option setting part 200 is applied according to an embodiment of the present general inventive concept is a device to generate and send print data to an image-forming apparatus 300. The image-forming apparatus 300 may be connected through a communication network 10, which can be formed by connecting a cable to a parallel port, connecting a cable to a universal serial bus (USB) port, or a local area network (LAN).

In some embodiments of the present general inventive concept, a host computer is employed as the print data output apparatus 100, in which a printer driver unit 160 relating to the image-forming apparatus 300 is installed, and a printer may be employed as the image-forming apparatus 300.

The print data output apparatus 100 includes a user input unit 110, a graphic card 120, a display unit 125, a central processing unit (CPU) 130, a read only memory (ROM) 140, a random access memory (RAM) 145, an application program unit 150, the printer driver unit 160, a spooler 170, a port monitor 180, and a communication interface unit 190. A bus 100a may constitute a data transfer path between the components listed above.

The user input unit 110 is a user interface to request a function supported by the print data output apparatus 100, which may include a keyboard, a mouse, a touch panel, or the like. In the present general inventive concept, the user input unit 110 provides a print request signal to request printing of a document to the CPU 130.

The graphic card 120 processes a video signal into a displayable signal as an output to the display unit 125. In particular, the graphic card 120 applies signal processing to a print option setting window provided by the printer driver unit 160 for an output to the display unit 125.

The display unit 125 may be a monitor implemented with a Cathode Ray Tube (CRT), a Liquid Crystal Display (LCD), or the like, which displays the print option setting window provided by the graphic card 120.

The CPU 130 uses various stored control programs, and controls overall operations of the print data output apparatus 100. In the present general inventive concept, when receiving a print request signal from the user input unit 110, the CPU 130 runs print-related application programs and the printer driver unit 160.

The ROM 140 is a non-volatile memory device and is used to store various control programs necessary to carry out the functions of the print data output apparatus 100.

The RAM 145 is a volatile memory device, and stores data and/or the control programs to be run by the CPU 130 that may be loaded from the ROM 140. The RAM 145 may also store data processed by the CPU 130.

The application program unit 150 is provided for application programs with which users can create various documents. If a user wishes to print a document created in the application program unit 150, the application program unit 150 provides the printer driver unit 160 with the document and attribute information associated with the document. The attribute information associated with the document includes at least one of a time when the document was last updated and stored, a month and date format, a file name, a file size, and/or a storage location of the document. Other attributes may also be included in the attribute information associated with the document.

The application programs can include word processors, database programs, web browsers, development tools, paint brush programs, image-editing programs, etc.

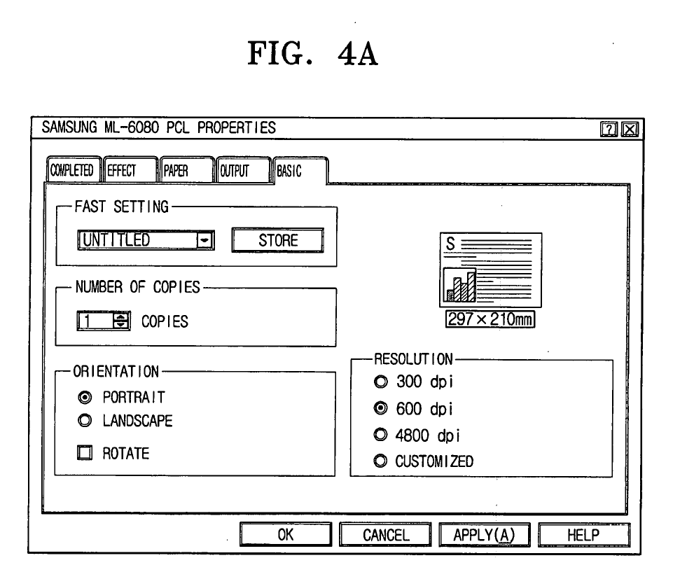

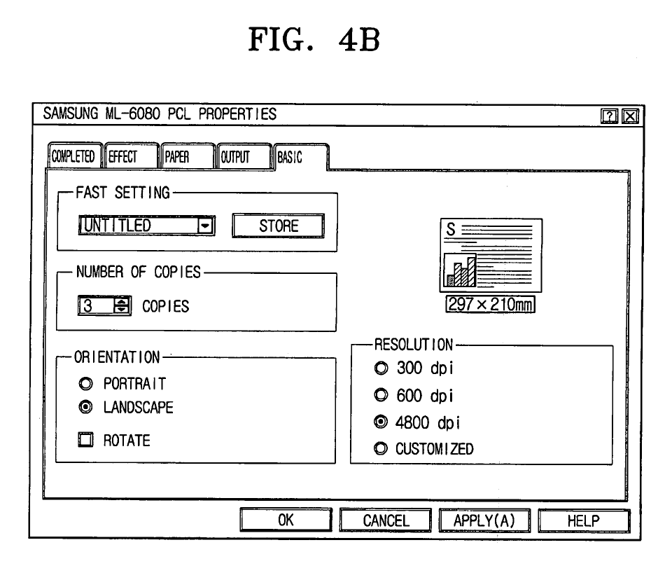

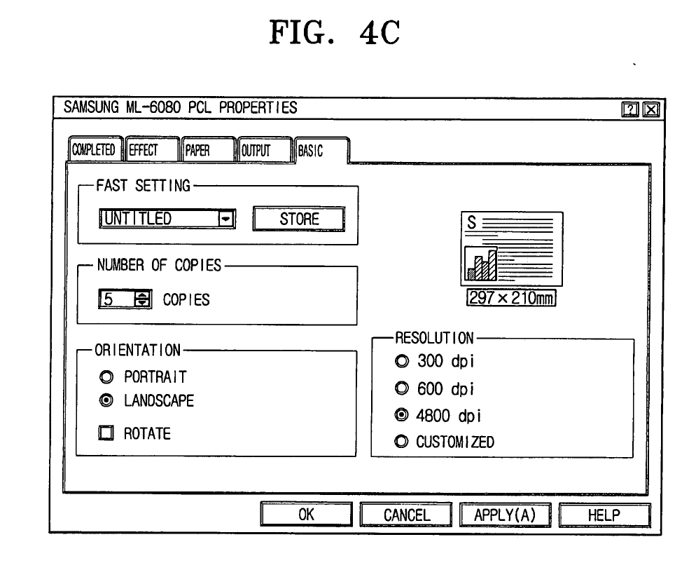

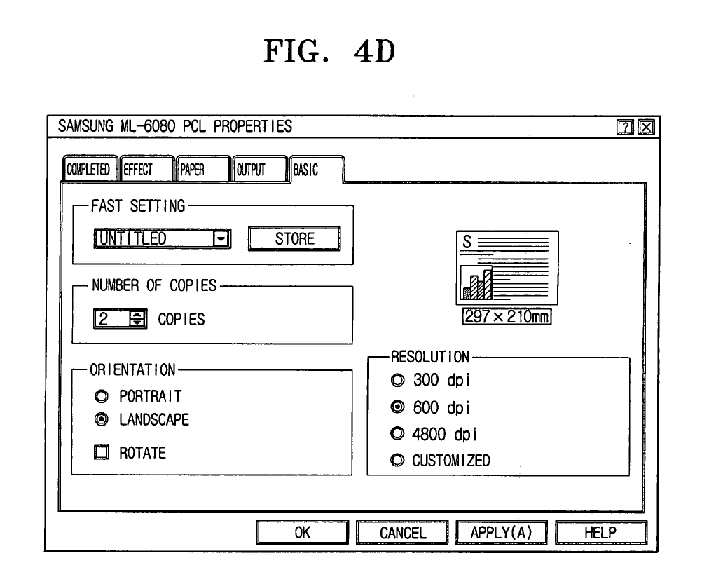

The printer driver unit 160 converts the document, the attribute information associated with the document, and print option setting information into print data. Further, as illustrated in FIG. 4A, the printer driver unit 160 provides the print option setting window and enables the user to set the print option setting information (i.e., print options) for the document.

The print data has a data format that the image-forming apparatus 300 can recognize. Further, the print options may include at least one of a paper size, a number of copies per page, a page (or print) range, an orientation, a number of copies, and a print quality (or resolution). Each of the print options has a default value set when the printer driver unit 160 is initially installed.

As illustrated in FIG. 4A, the default value of the orientation may, for example, be set to ‘portrait’, and the default value of the number of copies may be set to ‘1’. The default values of the print options can be changed using the user input unit 110.

As illustrated in FIG. 1, the printer driver unit 160 includes the print option setting part 200 to set the print options for the document. As illustrated in FIG. 2, the print option setting part 200 includes a setting information management unit 210, a setting information decision unit 220, and a setting window generation unit 230.

When a document is to be printed for the first time, the default values of the print options are changed to a first setting information, which is new, and if the document is printed based on the first setting information, the setting information management unit 210 stores the first setting information. That is, the first setting information corresponds to the print options used when the document is most recently printed.

The setting information management unit 210 stores the first setting information to correspond to the attribute information associated with the printed document. For example, if the document is printed with the number of copies changed from ‘1’ to ‘3’, the setting information management unit 210 stores the first setting information having the number of copies changed to ‘3’. Unchanged default values may also be stored with the number of copies that has been changed, or with other unchanged print options.

As illustrated in FIG. 2, the attribute information associated with a document requested to be printed is input from the setting information decision unit 220, and the setting information management unit 210 determines whether to store the first setting information corresponding to the input attribute information associated with the document requested to be printed. Next, the setting information management unit 210 outputs a result of the determination to the setting information decision unit 220.

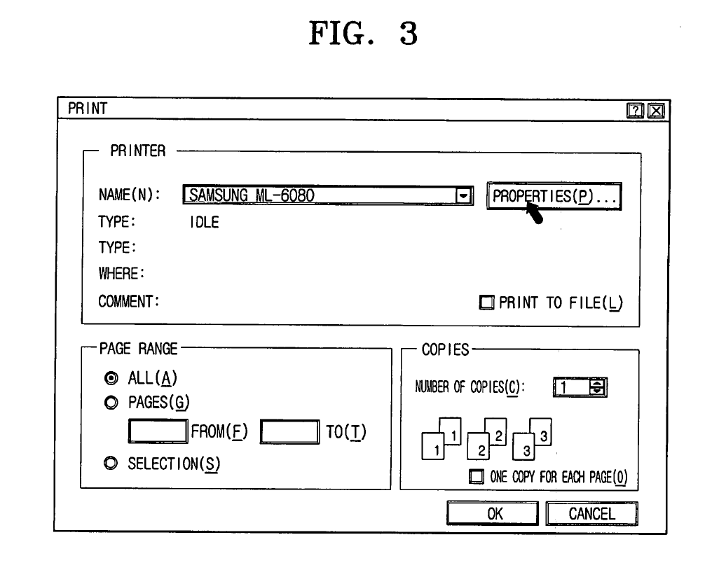

If a print request for a document is received from the user input unit 110, the printer driver unit 160 displays on the display unit 125 a print option setting window as illustrated in FIG. 3. Further, if a ‘registration information’ function is selected through the user input unit 110, the setting information decision unit 220 determines whether the document for which the print request is received has been printed with print options other than the default values.

In particular, referring to FIG. 2, if a print request is received for a document, the setting information decision unit 220 outputs to the setting information management unit 210 the attribute information associated with the document output from the application program unit 150. The setting information management unit 210 determines whether to store the first setting information corresponding to the attribute information associated with the document according to whether any setting information corresponding to the attribute information associated with the document is currently stored in the setting information management unit 210, and outputs a result of the determination to the setting information decision unit 220. The setting information decision unit 220 determines whether the document has been printed using the first setting information and outputs a result of the determination to the setting window generation unit 230. The setting information decision unit 220 determines whether the document has been printed using the result of the determination of the setting information management unit 210.

For example, if the result of the determination is a ‘0’, the setting information decision unit 220 determines that the document has been printed with the first setting information and the first setting information has been stored in the setting information management unit 210 and outputs a first decision result. On the other hand, if the result of the determination is a ‘1’, the setting information decision unit 220 determines that the document has not been printed or has been printed with the default values and outputs a second decision result.

The setting window generation unit 230 generates a print option setting window (see FIG. 3) displayed on the display unit 125 based on the result of the determination from the setting information decision unit 220 (i.e., the first decision result or the second decision result).

In particular, if the first decision result is output from the setting information decision unit 220, the setting window generation unit 230 queries the setting information management unit 210 for the first setting information. The setting information management unit 210 searches for the first setting information corresponding to the query, and outputs the first setting information to the setting window generation unit 230. Thus, the setting window generation unit 230 generates the print option setting window to include the first setting information as illustrated in FIG. 4B and outputs the print option setting window to the display unit 125.

Further, if an ‘OK’ button is selected with the user input unit 110, the printer driver unit 160 converts the document, the attribute information associated with the document, and the first setting information into print data. That is, if the print options in the print option setting window of FIG. 4B are set, the document is printed in three pages in landscape orientation and with the print quality of 4800 dpi based on the first setting information. Further, simply by displaying the print options (other than the default values) in the print option setting window of FIG. 4B, the print option setting window of FIG. 4B indicates that the document has previously been printed with the set print options.

On the other hand, after the print option setting window illustrated in FIG. 4A is displayed and the default values are changed to a third setting information by the user input unit 110, the setting window generation unit 230 generates the print option setting window illustrated in FIG. 4D. As illustrated in FIG. 4D, the third setting information includes information of ‘2’ for the number of copies and ‘landscape’ for the orientation.

After the print option setting window illustrated in FIG. 4D is displayed and the ‘OK’ button is selected through the user input unit 110, the setting information management unit 210 updates the default values according to the third setting information. That is, the setting information management unit 210 matches the third setting information with the attribute information associated with a document requested to be printed, for storage. Further, the printer driver unit 160 converts the document, the attribute information associated with the document, and the third setting information into print data. Accordingly, the document is printed based on the third setting information.

Referring back to FIG. 1, the spooler 170 provides the print data output from the printer driver unit 160 to the port monitor 180 according to a processing rate of the image-forming apparatus 300. In general, the spooler 170 may provide the print data page by page.

The port monitor 180 monitors ports electrically and physically connected to the image-forming apparatus 300 in order for the print data provided from the spooler 170 to be supplied to the image-forming apparatus 300 through the connected ports.

The communication interface unit 190 is provided with a plurality of ports, and at least one of the plurality of ports is connected to the image-forming apparatus 300. The plurality of ports can include an LPT port, a network port, USB ports, etc. The communication interface unit 190 sends the print data of a document requested to be printed to the image-forming apparatus 300 through the communication network 10.

If the print data output apparatus 100 is provided with a hard disc drive, the application program unit 150, printer driver unit 160, and spooler 170 can be installed using the hard disc drive.

The image-forming apparatus 300 prints the print data sent from the print data output apparatus 100 onto one or more sheets of paper. For example, if the first setting information is included in the sent print data, the image-forming apparatus 300 prints a document based on the first setting information.

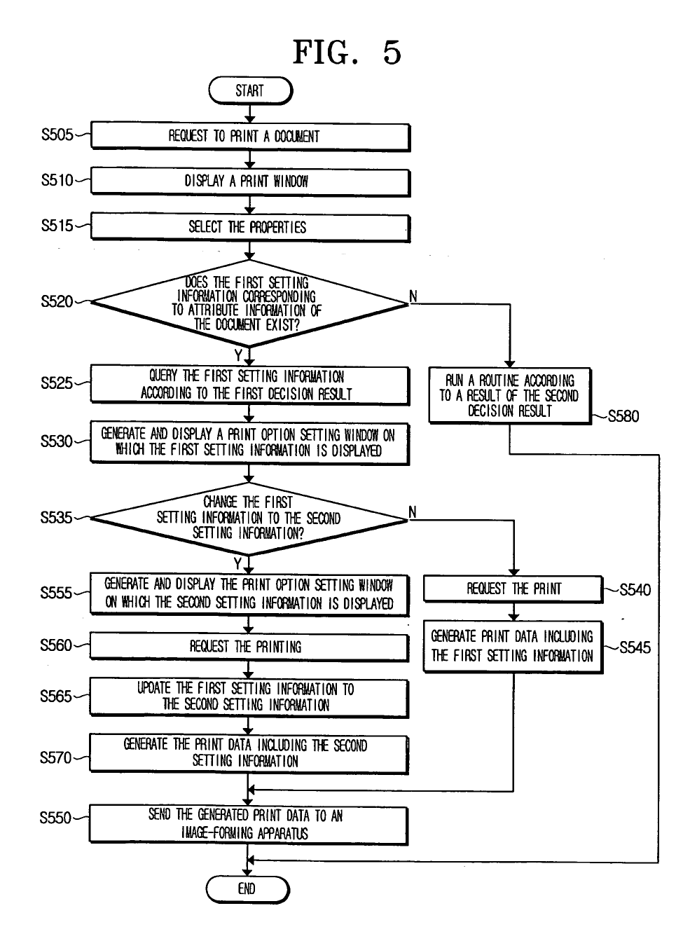

FIG. 5 is a flow chart schematically illustrating a method of printing documents using the print option setting part of FIG. 1.

Referring to FIG. 1 through FIG. 5, if a user requests that a document be printed using the user input unit 110, the application program unit 150 displays the print option setting window of FIG. 3 on the display unit 125 (operations S505 and S510).

If the user selects the ‘registration information’ function through the user input unit 110 after the print option setting window is displayed, the setting information decision unit 220 determines whether the first setting information corresponding to the attribute information associated with the document to be printed according to the user's request is stored by the setting information management unit 210 (operations S515 and S520).

If the setting information decision unit 220 determines that the setting information management unit 210 has the first setting information in the operation S520, the setting information decision unit 220 outputs a first decision result to the setting window generation unit 230. That is, the setting information decision unit 220 determines that the document requested to be printed has previously been printed based on the first setting information.

If the first decision result is output by the setting information decision unit 220, the setting window generation unit 230 queries the setting information management unit 210 for the first setting information (operation S525).

If the first setting information corresponding to the query is output from the setting information management unit 210 to the setting window generation unit 230 in the operation S525, the setting window generation unit 230 generates and outputs on the display unit 125 a print option setting window to include the first setting information as illustrated in FIG. 4B (operations S525 and S530).

If the first setting information is not changed before printing to the second setting information through the user input unit 110, and the ‘OK’ button (see FIG. 4B) is selected to start the printing of the document (operations S535 and S540), the printer driver unit 160 converts the document, the attribute information associated with the document, and the first setting information into the print data using the printer driver (operation S545).

The converted print data to be printed is sent to the image-forming apparatus 300 through the communication interface unit 190 (operation S550).

However, if the first setting information is changed before printing to the second setting information through the user input unit 110 after the operation S530 (i.e., after the print option setting window including the first setting information is displayed), the setting window generation unit 230 generates and outputs on the display unit 125 a print option setting window on which the second setting information is displayed (operations S535 and S555). For example, if the number of copies of the print option setting window of FIG. 4B is changed from ‘3’ to ‘5’, the setting window generation unit 230 generates the print option setting window illustrated in FIG. 4C.

If the ‘OK’ button (see FIG. 4C) is selected on the user input unit 110 to start the printing after the operation S555, the setting information management unit 210 updates the first setting information to the second setting information (operations S560 and S565). That is, the setting information management unit 210 matches the second setting information with the attribute information associated with the document, for storage. Further, the printer driver unit 160 converts the document, the attribute information associated with the document, and the second setting information into the print data (operation S570).

The converted print data to be printed is sent to the image-forming apparatus 300 through the communication interface unit 190 (operation S550).

On the other hand, if the second decision result is output in the operation S520, a routine according to the second decision result is performed (operation S580).

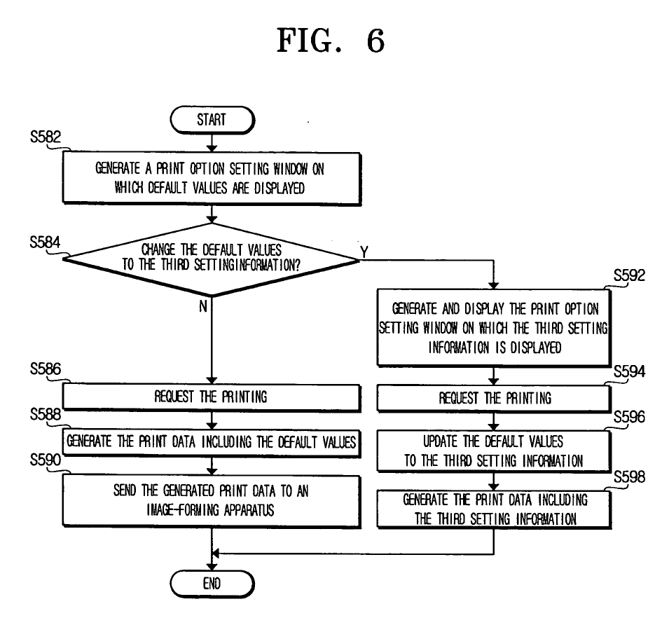

FIG. 6 is a flow chart illustrating the routine of the operation S580 of FIG. 5.

Referring to FIG. 1 through FIG. 6, if the setting information decision unit 220 determines that the setting information management unit 210 does not have the first setting information corresponding to the attribute information associated with the document in the operation S520, the setting information decision unit 220 outputs the second decision result to the setting window generation unit 230.

If the second decision result is output from the setting information decision unit 220, the setting window generation unit 230 generates and displays on the display unit 125 the print option setting window based on the default values illustrated in FIG. 4A (operation S582).

If the default values are not changed through the user input unit 110 and the ‘OK’ button (see FIG. 4A) is selected to start the printing of the document after the print option setting window of FIG. 4A is displayed (operations S584 and S586), the printer driver unit 160 converts the requested document, the attribute information associated with the document, and the default values into the print data (operation S588).

The converted print data is sent to the image-forming apparatus 300 through the communication interface unit 190, and is printed based on the default values (operation S590).

On the other hand, if the default values are changed before printing to the third setting information through the user input unit 110 after the print option setting window of FIG. 4A is displayed, the setting window generation unit 230 generates and outputs on the display unit 125 the print option setting window to include the third setting information (operations S584 and S592). For example, if the number of copies is changed from ‘1’ to ‘2’ and the paper orientation is changed from ‘portrait’ to ‘landscape’ on the print option setting window illustrated in FIG. 4A, the setting window generation unit 230 generates the print option setting window illustrated in FIG. 4D.

If the ‘OK’ button (see FIG. 4D) is selected to start the printing through the user input unit 110 after the operation S592, the setting information management unit 210 updates the default values to the third setting information (operations S594 and S596). That is, the setting information management unit 210 matches the third setting information with the attribute information associated with the requested document, for storage. Further, the printer driver unit 160 converts the document, the attribute information associated with the document, and the third setting information into the print data (operation S598).

The converted print data is sent to the image-forming apparatus 300 through the communication interface unit 190, and is printed based on the third setting information (operation S590).

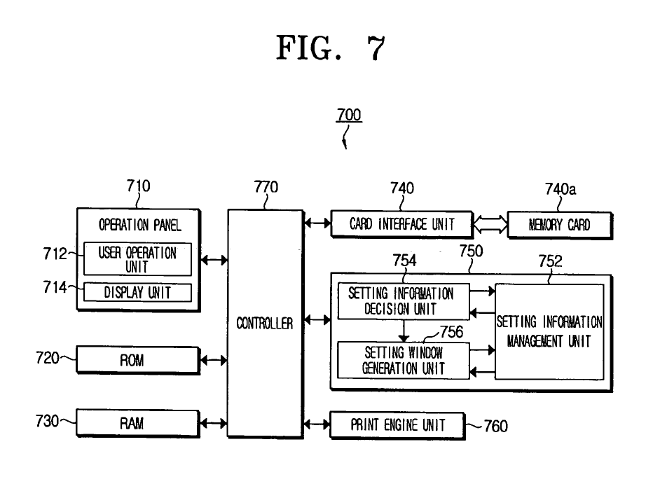

FIG. 7 is a block diagram illustrating an image-forming apparatus to which a print option setting part is applied according to an embodiment of the present general inventive concept.

The image-forming apparatus 700 illustrated in FIG. 7 is an apparatus that performs print tasks, and is described below with reference to a photo printer. However, the image forming apparatus 700 may include other types of devices. The photo printer is a printer to print still images or moving pictures taken by an image-capturing device such as a digital camera or a camcorder. Hereinafter, the still images or moving pictures are simply referred to as images.

As illustrated in FIG. 7, the image-forming apparatus 700 according to the present general inventive concept includes an operation panel 710, a ROM 720, a RAM 730, a card interface unit 740, a print option setting part 750, a print engine unit 760, and a controller 770.

The operation panel 710 includes a user operation unit 712 and a display unit 714. The user operation unit 712 is provided with a plurality of keys, a touch panel, and/or the like so that a user can select and set functions that the image-forming apparatus 700 supports, and can apply a selected signal to the controller 770. The display unit 714 displays an operation state of the image-forming apparatus 300 according to the controls of the controller 770. The display unit 714 may include an LCD panel.

The ROM 720 is a memory to store various control programs necessary to implement the functions of the image-forming apparatus 700, and the RAM 730 is a memory to store various data produced during operation of the image-forming apparatus 700.

The card interface unit 740 includes at least one memory card 740a. The card interface unit 740 can be an interface unit such as at least one slot, USB ports to use USB communication protocol, or an IEEE 1394 port.

The memory card 740a stores images taken by an image-capturing device (not shown). The memory card 740a can be a USB memory, a Compact Flash, a Smart Media, a Memory Stick, a Secure Digital (SD), a Multimedia Card (MMC), a Micro Drive (MD), etc.

The print option setting part 750 according to the present embodiment includes a setting information management unit 752, a setting information decision unit 754, and a setting window generation unit 756. Since functions and operations of the print option setting part 750 of FIG. 7 are similar to the print option setting part 200 illustrated in FIG. 2, and are described above, a description of the print option setting part 750 is omitted. The print option setting part 750 may be installed in the image-forming apparatus 700 in one module.

If printing is requested for an image stored in the memory card 740a through the user operation unit 712, the setting information decision unit 754 outputs attribute information associated with the image to the setting information management unit 752. The setting information management unit 752 determines whether a fourth setting information including print options that correspond to the attribute information associated with the image exists in the setting information management unit 752, and outputs a result of the determination to the setting information decision unit 754.

If the setting information decision unit 754 determines that the fourth setting information corresponding to the attribute information associated with the image exists in the setting information management unit 752, the setting information decision unit 754 determines that the image has previously been printed based on the fourth setting information, and outputs a result of the determination to the setting window generation unit 756.

The setting window generation unit 756 inputs the fourth setting information from the setting information management unit 752 according to the result of the determination that the fourth setting information exists in the setting information management unit 752. Further, the setting window generation unit 756 generates a print option setting window to include the fourth setting information. The generated print option setting window is displayed on the display unit 714. The user can use the user operation unit 712 to change the fourth setting information to a fifth setting information. If the image is printed based on the fifth setting information, the setting information management unit 752 updates the information from the fourth setting information according to the fifth setting information.

On the other hand, if the setting information decision unit 754 determines that the fourth setting information corresponding to the attribute information associated with the image does not exist in the setting information management unit 752, the setting information decision unit 754 determines that the image has not previously been printed based on the fourth setting information, and outputs the result of the determination to the setting window generation unit 756.

As a result, the setting window generation unit 756 generates a print option setting window to include the default values of the print options, according to the result of the determination that the fourth setting information does not exist in the setting information management unit 752. The generated print option setting window is displayed on the display unit 714. The user can use the user operation unit 712 to change the default values of the print options to a sixth setting information. If the image is printed based on the sixth setting information, the setting information management unit 752 updates the default values according to the sixth setting information. It should be understood that the sequential references used to refer to the print option setting information (i.e., first, second, third, fourth, fifth, and sixth setting information) are not meant to limit the scope of the present general inventive concept, and the references are merely used to refer to distinct print option setting information.

Thus, whenever a user wishes to repeatedly print an image printed according to a specified print option setting information rather than previous default values, the user does not have to make efforts to repeatedly set the same specified print option setting information as previously set, since the previously set specified print option setting information is stored with attribute information associated with the image. Further, image-specific print option setting information may be stored to correspond to attribute information of a plurality of images.

The print engine unit 760 prints the image on one or more sheets of paper according to the controls of the controller 770.

The controller 770 controls overall operations of the image-forming apparatus 700 according to a control program stored in the ROM 720. In the present general inventive concept, if the memory card 740a is installed in the card interface unit 740, the controller 770 reads the attribute information associated with the image stored in the memory card 740a, and controls the card interface unit 740 to provide the attribute information associated with the image to the print option setting part 750. Further, if specified print options are set through the print option setting part 750, the controller 770 controls the print engine unit 760 to print the read image based on the setting information of the specified print options that have been set.

On the other hand, in the embodiment of the present general inventive concept described with reference to FIG. 1 through FIG. 7, if a predetermined time lapses after the default values of the print options are changed, the setting information management units 210 and 752 can automatically delete the setting information of the changed print options (i.e., the first, second, third, fourth, fifth, or sixth setting information). Further, if a predetermined time lapses without a re-print request after the default values of the print options are changed to a different print option setting information, the setting information management unit 210 can automatically delete the setting information of the changed print options (i.e., the first, second, third, fourth, fifth, or sixth setting information). Thus, if the re-print request is made with respect to a document that has been printed after the automatic deletion, the print option setting window again displays the default values of the print options. As a result of the automatic deletion, storage space used to store the print setting information for one or more documents and/or images may be conserved.

Further, the print option setting parts 200 and 750 can selectively apply the present general inventive concept depending on the document or image file formats. That is, the present general inventive concept can be applied if extensions of document names of the document or image files are included in a predetermined group of specified extensions.

For example, if the predetermined group of specified extensions include ‘*.gul,’ ‘*.hwp,’ and ‘*.jpg’ and a print-requested document has the extension of ‘*.doc,’ the setting information for the document other than the default values is not stored even though the document is printed based on the setting information other than the default values. Thus, if a re-print request is made with respect to the same document, the screen again displays a print option setting window to include the default values of the print options.

As described above, a print option setting apparatus and method according to the present general inventive concept enable a user to use the same print option setting information as previously set to print a document, without additional user input and/or selections, when the user re-prints the document, since the print option setting information previously used to print the document is separately stored to correspond to the attribute information associated with the document.

Further, if the print option setting information previously used to print the document is changed, the changed print option setting information can be updated to correspond to the attribute information associated with the document. Additionally, since the print option setting information may be stored to correspond to attribute information associated with a document or image, a plurality of different print option setting information can be stored to correspond to a plurality of different attribute information associated with a plurality of documents or images. As a result, the present general inventive concept may store print option setting information for a plurality of different documents and/or images. Thus, when a user requests a specified document to be printed, a print option setting information that corresponds to the specified document is displayed in a print option setting window. If a print option setting information that corresponds to the specified document does not exist, a default print option setting information is displayed. Additionally, the user can change and re-change the print option setting information that corresponds to the specified document.

Accordingly, the print option setting information that is previously used to print the document is automatically displayed when a user wants to subsequently re-print the same document. As a result, the user can avoid efforts to repeatedly input the same print option setting information. Further, the user does not have to remember the print option setting information previously used to print the document.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A print option setting method to set print options of a document, the method comprising:
receiving a user input signal to request printing of the document;
determining whether a first setting information of the print options corresponding to the document requested to be printed exists in a storage unit; and
if it is determined that the first setting information set in a previous printing of the document exists in the storage unit, displaying a print option setting window to include the first setting information.

2. The print option setting method as claimed in claim 1, wherein the determining whether a first setting information of the print options corresponding to the document requested to be printed exists in the storage unit comprises checking attribute information of the document and, if the first setting information corresponding to the checked attribute information exists, determining that the document has previously been printed based on the first setting information.

3. The print option setting method as claimed in claim 2, wherein the displaying a print option setting window comprises:
displaying the print option setting window to include the first setting information; and
printing the document based on the displayed first setting information according to the user input signal.

4. The print option setting method as claimed in claim 3, wherein, if the first setting information is changed to a second setting information according to the user input signal, the printing of the document based on the displayed first setting information according to the user input signal comprises:
displaying the second setting information on the print option setting window, and
printing the document based on the changed second setting information.

5. The print option setting method as claimed in claim 4, further comprising:
updating the first setting information to the second setting information for storage in the storage unit.

6. The print option setting method as claimed in claim 2, further comprising:
if it is determined that the first setting information corresponding to the checked attribute information does not exist in the storage unit, displaying the print option setting window to include default values of the print options.

7. The print option setting method as claimed in claim 6, wherein, if the document is printed after the default values displayed on the print option setting window are changed to a second setting information, matching the second setting information with the attribute information of the document for storage in the storage unit.

8. The print option setting method as claimed in claim 6, wherein, if a predetermined time lapses after the default values of the print options are changed to the first setting information, deleting the first setting information from the storage unit.

9. The print option setting method as claimed in claim 1, wherein the determining whether a first setting information of the print options corresponding to the document requested to be printed exists in the storage unit is selectively performed when a file format of the document is included in a predetermined group of specified formats.

10. The print option setting method as claimed in claim 2, wherein the print options include at least one of a paper size, a number of copies per page, a print range, a print orientation, a number of copies, and a print quality, and the attribute information includes at least one of a most recent edit date of the document, a file name of the document, a file size of the document, and a storage location of the document.

11. The print option setting method as claimed in claim 1, wherein the print option setting apparatus is installed in one of a printer driver and an image-forming apparatus that prints the document.

12. A method of setting print options for a document to be printed, the method comprising:
receiving at least one first print request to print at least one document together with selections of at least one set of print options corresponding with the at least one document;
printing the at least one document according to the corresponding selections of print options and storing the selections of print options corresponding with the at least one document in a storage unit;
receiving a second print request to print a specified one of the at least one document and automatically selecting the set of print options corresponding with the specified one of the at least one document; and
displaying the automatically selected set of print options corresponding with the specified one of the at least one document in a print option setting window.

13. A method of setting print options to print a document, the method comprising:
storing a plurality of document-specific print options for one or more documents; and
retrieving the document-specific print options corresponding with the one or more documents to be printed.

14. A print option setting apparatus to set print options of a document, comprising:
a setting information decision unit to determine whether a first setting information corresponding to the document exists when printing of the document is requested;
a setting information management unit to store the first setting information, which is set in a previous printing of the document; and
a setting window generation unit to input the first setting information from the setting information management unit when it is determined that the first setting information exists in the setting information management unit, and to generate and display a print option setting window to include the first setting information.

15. The print option setting apparatus as claimed in claim 14, wherein, if the setting information decision unit determines that the first setting information corresponding to attribute information associated with the document exists in the setting information management unit, the setting information decision unit determines that the document has previously been printed based on the first setting information.

16. The print option setting apparatus as claimed in claim 15, wherein, if the first setting information displayed on the print option setting window is changed to a second setting information through a user input unit, the setting window generation unit generates the print option setting window to include the second setting information.

17. The print option setting apparatus as claimed in claim 16, wherein, if the document is printed based on the second setting information, the setting information management unit updates the first setting information according to the second setting information for storage in the setting information management unit.

18. The print option setting apparatus as claimed in claim 14, wherein, if the setting information decision unit determines that the first setting information does not exist in the setting information management unit, the setting window generation unit generates the print option setting window to include default values of the print options.

19. The print option setting apparatus as claimed in claim 18, wherein, if printing is requested after the default values displayed on the print option setting window are changed to a second setting information through the user input unit, the setting information management unit matches the second setting information with the attribute information associated with the document for storage in the setting information management unit.

20. The print option setting apparatus as claimed in claim 19, wherein, if a predetermined time lapses after the default values of the print options are changed to either the first or the second setting information, the setting information management unit deletes the first or the second setting information to which the default values are changed from the setting information management unit.

21. The print option setting apparatus as claimed in claim 14, wherein the setting information management unit determines whether the first setting information exists in the setting information management unit when a file format of the document is included in a predetermined group of specified formats.

22. The print option setting method as claimed in claim 15, wherein the print options include at least one of a paper kind, a number of copies per page, a print range, a print orientation, and a resolution, and the attribute information includes at least one of a most recent edit date of the document, a file name of the document, a file size of the document, and a storage location of the document.

23. An apparatus to set print options for a document to be printed, comprising:
an input unit to receive at least one first print request to print at least one document, to receive selections of at least one set of print options corresponding with the at least one document, and to control an image forming part to print the at least one document according to the corresponding at least one set of print options;
a setting information management unit to store the at least one set of print options that correspond with the at least one document and to automatically select the set of print options that corresponds with a specified one of the at least one document when a second print request to print the specified one of the at least one document is received by the input unit; and
a setting window unit to retrieve and display the automatically selected set of print options that corresponds with the specified one of the at least one document in a print option setting window.

24. An apparatus to set print options to print a document, comprising:
a setting information management unit to store document-specific print options for one or more documents; and
a setting window generation unit to retrieve the document-specific print options corresponding with the one or more documents to be printed.
